(19) United States
(12) Patent Application Publication
(10) Pub. No.: US 2017/0048225 A1
(43) Pub. Date: Feb. 16, 2017

(54) Method, Apparatus, and System for Secure Authentication

(71) Applicant: Alibaba Group Holding Limited, Grand Cayman (KY)

(72) Inventors: Dong GUO, Hangzhou (CN); Chao DENG, Hangzhou (CN); Tingliang CHEN, Hangzhou (CN)

(21) Appl. No.: 15/234,642

(22) Filed: Aug. 11, 2016

(30) Foreign Application Priority Data
Aug. 14, 2015 (CN) 201510497438.X

(51) Int. Cl. H04L 29/06

(52) U.S. Cl. CPC H04L 63/08; H04L 63/062; G06F 2221/2151

(57) ABSTRACT

An apparatus and method allowing secure authentication between an application platform and a service invoker. The method includes generating, by the service invoker, a first signature based on a locally stored token, adding, by the service invoker, the first signature and an identification of the service invoker to a service invocation request, and transmitting, by the service invoker, the service invocation request to the application platform for secure authentication based on the first signature and the identification of the service invoker. The application platform, receives the service invocation request transmitted by the service invoker, and performs a secure authentication on the service invocation request based on the first signature and the identification of the service invoker.

### CROSS-REFERENCE TO RELATED APPLICATIONS

This application claims the benefit of priority from Chinese Patent Application No. 201510497438.X, filed on Aug. 14, 2015, entitled “Method, Apparatus and System for Security Authentication,” which is incorporated herein by reference in its entirety.

### BACKGROUND

Field of the Disclosure

The present disclosure relates to identity authentication systems, and in particular, to a secure authentication method, apparatus, and system allowing identity authentication not based on the login of a user.

Description of the Related Art

Under the current background of cloud computing and big data, data providers, service developers and service users have increasingly greater demands on data access, data exchange, data submission, service secondary development, and the like, on application platforms based on big data, and therefore, ensuring the security of the application platform becomes a very important problem.

Currently, there are some conventional token-based identity authentication systems in the industry; however, these types of systems are mostly based on a session or a cookie, and are identity verification methods requiring a user login. However, for an application platforms based on big data, a user frequently needs to invoke a service provided by the application platform in a non-logged in state; therefore, existing application platforms are unable to perform secure authentication based on a session or a cookie.

### SUMMARY

Various aspects of the present disclosure provide a secure authentication method and apparatus, so as to implement secure authentication in a non-logged in state, thereby improving the security of an application platform.

One aspect of the present disclosure is drawn to a method for securely authenticating a service invoker. The method includes generating, by the service invoker, a first signature based on a locally stored token, generating, by the service invoker, a service invocation request by adding the first signature and an identification of the service invoker to a service invocation request, and transmitting, by the service invoker, the service invocation request to the application platform for secure authentication based on the first signature and the identification of the service invoker.

One aspect of the present disclosure is drawn to a method for secure authentication between an application platform and a service invoker. The method includes receiving, by the application platform, a service invocation request transmitted by the service invoker, the service invocation request including a first signature generated by the service invoker based on a locally stored token and an identification of the service invoker, and performing, by the application platform, a secure authentication of the service invocation request according to the first signature and the identification of the service invoker.

One aspect of the present disclosure is drawn to an apparatus for securely authenticating a service invoker. The apparatus includes a processor and a non-transitory memory storing computer-executable instructions. When executed by the processor, the instructions cause the apparatus to generate a first signature based on a locally stored token, generate a service invocation request, wherein generating a service invocation request comprises adding the first signature and an identification of the service invoker to a service invocation request, and transmit the service invocation request to an application platform for secure authentication based on the service invocation request according to the first signature and the identification of the service invoker.

One aspect of the disclosure is drawn to an apparatus for securely authenticating a service invoker. The apparatus includes a processor and a non-transitory memory storing computer-executable instructions. When executed by the processor, the instructions cause the apparatus to receive a service invocation request transmitted by an application platform, the service invocation request including a first signature generated by the service invoker according to a locally stored token, one or more service parameters required by the service invocation request, and a timestamp of the service invocation request, an identification of the service invoker, the one or more service parameters, and the timestamp.

The instructions also cause the apparatus to acquire a token of the service invoker according to the identification of the service invoker, generate a second signature according to the token of the service invoker, the one or more service parameters, and the timestamp, a determining module configured to determine whether the first signature is the same as the second signature, and determine whether the timestamp has expired, and, if the first signature is the same as the second signature and the timestamp has not expired, return an authentication result to the application platform indicating a secure authentication success, and if the first signature is different from the second signature or the timestamp has expired, return an authentication result to the application platform indicating a secure authentication failure.

Thus, in the present disclosure, a service invoker acquires, in advance, a token required by authentication and stores the token locally. When needing to invoke a service provided by an application platform, the service invoker generates a first signature according to the locally stored token; adds the first signature and an identification of the service invoker to a service invocation request, and transmits the service invocation request to the application platform. The application platform performs a secure authentication on the service invocation request according to the first signature and the identification of the service invoker in the service invocation request. Since the service invoker acquires the token in advance and stores the token locally, it is not necessary to login to the application platform to acquire the token required by authentication, so that the service invoker can perform a secure authentication without logging in to the application platform (that is, from a non-logged in state).

### BRIEF DESCRIPTION OF THE DRAWINGS

In order to explain the technical solutions of embodiments of the present disclosure more clearly, a brief introduction of accompanying drawings to be used for describing the embodiments or the prior art will be made below. It is apparent that the accompanying drawings described below are for some embodiments of the present application, and are not intended to limit the scope of the disclosure, which is defined by the claims.

FIG. 1 presents a diagram of a secure authentication system according to some embodiments of the present disclosure.

FIG. 2 presents a flow diagram of a secure authentication method according to some embodiments of the present disclosure.

FIG. 3 presents a flow diagram of a secure authentication method according to some embodiments of the present disclosure.

FIG. 4 presents a flow diagram of a subprocess in a secure authentication method according to some embodiments of the present disclosure.

FIG. 5 presents a flow diagram of a subprocess in a secure authentication method according to some embodiments of the present disclosure.

FIG. 6 presents a flow diagram of a secure authentication method according to some embodiments of the present disclosure.

FIG. 7 presents a flow diagram of a subprocess in a secure authentication method according to some embodiments of the present disclosure.

FIG. 8 presents a flow diagram of a subprocess in a secure authentication method according to some embodiments of the present disclosure.

FIG. 9 presents a flow diagram of a subprocess in a secure authentication method according to some embodiments of the present disclosure.

FIG. 10 presents a flow diagram of a secure authentication method according to some embodiments of the present disclosure.

FIG. 11 presents a flow diagram of a subprocess in a secure authentication method according to some embodiments of the present disclosure.

FIG. 12 presents a diagram of a secure authentication apparatus according to some embodiments of the present disclosure.

FIG. 13 presents a diagram of a secure authentication apparatus according to some embodiments of the present disclosure.

FIG. 14 presents a diagram of a secure authentication apparatus according to some embodiments of the present disclosure.

FIG. 15 presents a diagram of a secure authentication apparatus according to some embodiments of the present disclosure.

### DETAILED DESCRIPTION

In order to make objectives, technical solutions, and advantages of the embodiments of the present disclosure clearer, the technical solutions in embodiments of the present disclosure will be described clearly and completely in combination with the accompanying drawings in the embodiments of the present disclosure. It is apparent that the described embodiments are only some of the embodiments of the present disclosure, and are not intended to be exhaustive. Based on the embodiments of the present disclosure, other embodiments derived by a person using only ordinary skill in the art without any creative effort are considered to fall within the scope of protection of the present disclosure.

The present disclosure remedies the aforementioned problem in the prior art that secure authentication is unable to be performed in a non-logged in state. A main principle is that a service invoker acquires, in advance, a token required by authentication and stores the token locally. When needing to invoke a service provided by an application platform, the service invoker generates a signature used for authentication directly according to the locally stored token, adds the signature and an identification of the service invoker to a service invocation request, and transmits the service invocation request to the application platform, so that the application platform can perform a secure authentication on the service invocation request according to the signature and the identification of the service invoker in the service invocation request. It can be seen that, the service invoker can directly initiate authentication directly to the application platform without logging in to the application platform, thereby solving the problem that a secure authentication is unable to be performed in a non-logged in state.

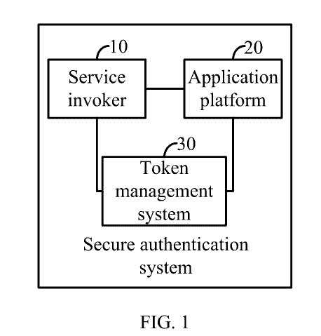

The technical solution provided in the present disclosure may be executed by a secure authentication system. According to the embodiment illustrated in FIG. 1 the secure authentication system includes a service invoker 10 and an application platform 20.

The service invoker 10 refers to a party that needs to invoke a service provided by the application platform 20. The application platform 20 is responsible for providing various services, for example, it may be an application platform implemented based on big data. “Data” in big data refers to data in the broad sense, for example, lists, user defined functions (UDF), data services, sheets, and so on.

In the application platform 20, various services may be distributed at different positions as service modules. Because of connections between services, mutual invocation between the service modules is required. This means that in one embodiment the service invoker 10 may be a service module within the application platform 20. During interaction of the service modules, the application platform 20 requires the service module initiating the service invocation to perform a secure authentication, so as to prevent illegal requests from inside the network.

In an alternative embodiment, the service invoker 10 may be a network device outside the application platform 20. The network device outside the application platform 20 may come from various network environments of a public network, and forms of requesting an invocation service include, but are not limited to, API invocations, shell scripts, UDF tasks, and the like. Therefore, the application platform 20 needs to perform a secure authentication on an external service invocation request to the application platform 20, so as to ensure that the request is legal.

Considering that the service invoker 10 may not log in to the application platform 20, but directly initiate the service invocation to the application platform, the secure authentication needs to be performed in a non-logged in state. Specifically, the service invoker 10 obtains a token used for authentication in advance and stores the token locally. When attempting to invoke a service provided by the application platform 20, the service invoker 10 generates a first signature according to the locally stored token, adds the first signature and an identification of the service invoker 10 to a service invocation request, and transmits the service invocation request to the application platform 20. The application platform 20 receives the service invocation request transmitted by the service invoker 10, and performs a secure authentication on the service invocation request according to the first signature and the identification of the service invoker 10 in the service invocation request.

For example, if the service invoker 10 is a network device outside the application platform 20, the application platform 20 can manage the external network user by setting a lessee group and a project space. The lessee is a client group using resources and/or services provided by the application platform 20, and different lessees have different identifiers. The project space is a place where network users process data under the application platform 20, and the network users can divide different project spaces for use according to different product lines. The project space is a basic unit for the network user to operate data resources, and belongs to the lessee. One lessee may have multiple project spaces, and different project spaces have different identifiers. In this example, the identification of the service invoker 10 may include: a user identifier, a lessee identifier, and a project space identifier.

For example, if the service invoker 10 is a service module within the application platform 20, the application platform 20 can centrally manage various service modules, and assign a base key for each service module to serve as an identification of the service module. In this example, the identification of the service invoker 10 specifically refers to the identification of the service module, for example, the base key.

In this system, the service invoker acquires the token in advance and stores the token locally, and therefore, it is not necessary to log in to the application platform to acquire the token required by authentication, so that the service invoker can perform a secure authentication without logging in to the application platform (that is, in a non-logged in state).

Further, as shown in FIG. 1, the secure authentication system further includes a token management system 30. The application platform 20 transmits the service invocation request to the token management system 30 to enable the token management system 30 to perform a secure authentication, and receives authentication result information returned by the token management system 30. The token management system 30 performs secure authentication on the service invocation request according to the first signature and the identification of the service invoker 10 in the service invocation request.

For example, the token management system 30 manages the mapping relationship between the service invoker 10 and the token used by the service invoker 10. Therefore, the token management system 30 can parse the service invocation request to obtain the identification of the service invoker 10; acquire the token of the service invoker 10 according to the identification of the service invoker 10, generate a second signature according to the acquired token, and compare the first signature with the second signature. If the two signatures are the same, the token management system 30 determines that the secure authentication succeeds, and returns authentication result information to the application platform 20 indicating a secure authentication success. If the two signatures are different, the token management system 30 determines that the secure authentication fails, and returns authentication result information to the application platform 20 indicating a secure authentication failure.

In some embodiments, a secure authentication can be performed separately for each service invocation request. In these embodiments, the service invoker 10 further uses one or more service parameters required by this service invocation and a timestamp of this service invocation when generating the first signature, in addition to the locally stored token. Different service invocations may have different timestamps, and one or more service parameters required by different service invocations may vary. Therefore, a service request can be identified uniquely by using the one or more service parameters required by this service invocation and the timestamp of this service invocation. Thus, performing a secure authentication by combining the token with the one or more service parameters required by the service invocation and the timestamp can achieve the effect of performing separate authentication on each service invocation, so as to solve the problem that existing single sign-on techniques are unable to perform separate authentication on each service invocation.

Specifically, the service invoker 10 generates a first signature according to the locally stored token, the one or more service parameters required by this service invocation, and the timestamp of this service invocation. The service invoker 10 then adds the first signature, the identification of the service invoker, the one or more service parameters required by this service invocation, and the timestamp of this service invocation to the service invocation request, and transmits the service invocation request to the application platform 20.

In some embodiments, generating the first signature includes combining the one or more service parameters required by this service invocation and the timestamp of this service invocation into an invocation parameter, dividing the invocation parameter according to separators (for example, “&”) in the invocation parameter to obtain multiple parameter segments, and sorting the parameter segments according to a character order (for example, by ascending order of characters) to obtain a first parameter sequence. Generating the first signature further includes adding the token at the beginning and at the end of the first parameter sequence respectively, so as to obtain a second parameter sequence, and encoding the second parameter sequence, and converting an encoding result into lowercase characters, so as to obtain the first signature. For example, SHA-256 encoding may be used to encode the second parameter sequence, but the present disclosure is not limited thereto.

It should be noted that, the manner of generating the first signature in this embodiment is not limited to the manner provided in the above embodiment, and various manners of generating signatures in the prior art are all applicable to this embodiment.

The application platform 20 receives the service invocation request transmitted by the service invoker 10, transmits the service invocation request to the token management system 30, and receives authentication result information returned by the token management system 30. If the authentication result information indicates that the secure authentication succeeds, the application platform 20 provides a corresponding service to the service invoker 10 according to a service function. Otherwise, the application platform 20 rejects the service invocation request of the service invoker 10 this time.

The token management system 30 receives the service invocation request transmitted by the application platform 20. The token management system 30 then acquires the token of the service invoker 10 according to the identification of the service invoker 10 in the service invocation request, generates the second signature according to the token of the service invoker 10, the one or more service parameters required by this service invocation and the timestamp of this service invocation, determines whether the first signature is the same as the second signature, and determines whether the timestamp of this service invocation has expired. If the first signature is the same as the second signature and the timestamp of this service invocation has not expired, the token management system 30 returns an authentication result information to the application platform 20 indicating a secure authentication success. If the first signature is different from the second signature or the timestamp of this service invocation has expired, the token management system 30 returns authentication result information to the application platform 20 indicating a secure authentication failure.

In some embodiments, generating the second signature includes combining the one or more service parameters required by this service invocation and the timestamp of this service invocation into an invocation parameter, dividing the invocation parameter according to separators (for example, “&”) in the invocation parameter to obtain multiple parameter segments, and sorting the parameter segments according to a character order (for example, by ascending order) to obtain a first parameter sequence. Generating the second signature further includes adding the token at the beginning and at the end of the first parameter sequence respectively, so as to obtain a second parameter sequence, and encoding the second parameter sequence, and converting an encoding result into lowercase characters, so as to obtain the second signature. For example, SHA-256 encoding may be used to encode the second parameter sequence, but the present disclosure is not limited thereto.

It should be noted that, the manner of generating the second signature in this embodiment is not limited to the manner provided in the above embodiment, and various manners of generating signatures in the prior art are all applicable to this embodiment.

However, in one secure authentication process, the manner of generating the first signature by the service invoker and the manner of generating the second signature by the token management system 30 must be consistent with each other.

In some embodiments, determining whether the timestamp of this service invocation has expired by the token management system 30 includes comparing whether a difference between the timestamp of the token management system 30 and the timestamp carried in the service invocation request received from the service invoker 10 exceeds a preset expiration threshold. If the difference between the two exceeds the expiration threshold, then the timestamp of this service invocation has expired. If the difference between the two does not exceed the expiration threshold, then the timestamp of this service invocation has not expired.

Further, the token management system 30 is responsible for generating the token for the service invoker 10 in advance. Before generating the first signature according to the locally stored token, the service invoker 10 applies for a token from the token management system 30, and locally stores the applied token generated by the token management system 30. Specifically, the service invoker 10 transmits a token application request to the token management system 30 to apply for the token. In one embodiment, the token application request includes an identification of the service invoker. The token management system 30 receives the token application request transmitted by the service invoker 10, generates a token for the service invoker 10, and transmits the generated token to the service invoker 10. The service invoker 10 receives the token generated by the token management system 30 for the service invoker 10.

The process of the token management system 30 generating the token for the service invoker 10 includes generating a random number. For example, the random number may be generated by using a SHA1PRNG algorithm, but the present disclosure is not limited to the SHA1PRNG algorithm. Generating the token also includes constructing an initial string according to the identification of the service invoker 10 and the random number. In one embodiment, the identification of the service invoker 10 and the random number are concatenated to serve as the initial string, and the token management system 30 encodes the initial string to generate the token. For example, the token management system 30 may utilize SHA-256 encoding to encode the initial string, but the present disclosure is not limited thereto.

It should be noted that, the manner of generating the token in this embodiment is not limited to the manner provided in the above embodiment, and various manners of generating a token in the prior art are all applicable to this embodiment.

The application platform 20 and the token management system 30 in the above system may be implemented on different devices, but may also be implemented on a single device.

In term of a hierarchical structure, a bottom layer of this system may adopt a data platform such as Apache Hadoop, Spark, or Storm, a middle layer may adopt an open data service management platform, and an upper layer may construct a data management and web system by using a computer programming language, a database, and the like.

This system can perform a secure authentication of a network device outside the platform or a service module inside the platform in a non-logged in state, and can perform separate secure authentication and expiration control on each service invocation request, thereby avoiding counterfeit or illegitimate requests and all unauthorized access attempts, and ensuring the security of the application platform.

The secure authentication process will be described from the perspectives of the service invoker and the application platform respectively in the following embodiments.

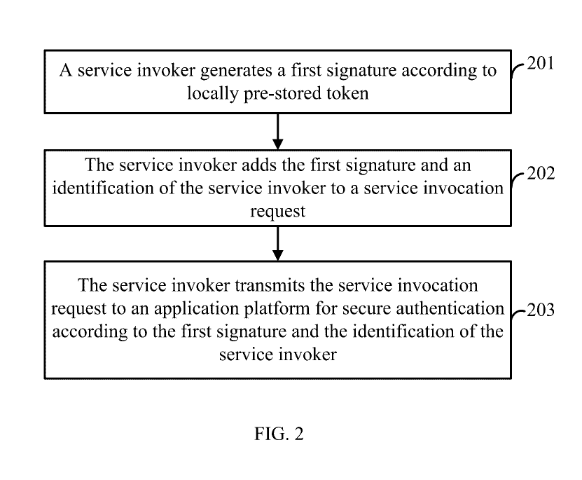

FIG. 2 presents a flow diagram of a secure authentication method according to some embodiments of the present disclosure. As shown in FIG. 2, the method includes steps 201 to 203.

In step 201, a service invoker generates a first signature according to a locally stored token.

In step 202, the service invoker adds the first signature and an identification of the service invoker to a service invocation request.

In step 203, service invoker transmits the service invocation request to an application platform, to enable the application platform to perform a secure authentication on the service invocation request according to the first signature and the identification of the service invoker.

In the illustrated embodiment, the service invoker acquires the token required by authentication in advance and stores the token locally. When attempting to invoke a service provided by the application platform, the service invoker generates the first signature required for authentication according to the locally stored token. It is not necessary for the service invoker to obtain the token required for authentication by logging in to the application platform; therefore, the service invoker can perform a secure authentication without logging in to the application platform (that is, in a non-logged in state).

In some embodiments, the implementation process of the step 201 includes the service invoker generating the first signature according to the locally stored token, one or more service parameters required by this service invocation, and a timestamp of this service invocation. Correspondingly, the implementation process of the step 202 then includes the service invoker adding the first signature, the identification of the service invoker, the one or more service parameters required by this service invocation and the timestamp of this service invocation to the service invocation request.

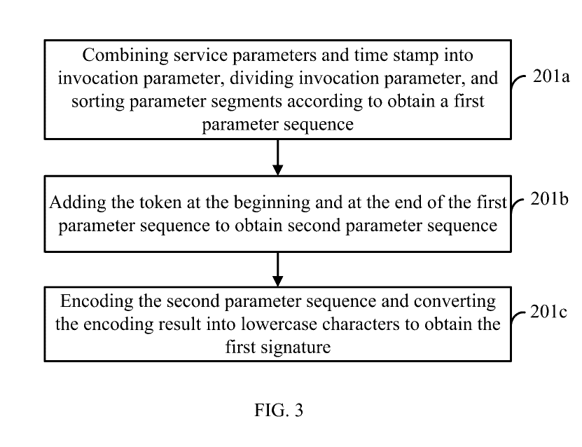

Further, in some embodiments, generation of a first signature by the service invoker according to the locally stored token, the one or more service parameters required by this service invocation, and the timestamp of this service invocation is illustrated in more detail in FIG. 3. As illustrated in FIG. 3, in step 201a the method combines the one or more service parameters required by this service invocation and the timestamp of this service invocation into an invocation parameter, dividing the invocation parameter according to separators (for example, “&”) in the invocation parameter to obtain multiple parameter segments, and sorts the parameter segments according to a character order (for example, by ascending order of characters) to obtain a first parameter sequence. In step 201b, the method then generates the first signature in step 201b, adding the token at the beginning and at the end of the first parameter sequence respectively, so as to obtain a second parameter sequence. In step 201c, the method encodes the second parameter sequence, and converts an encoding result into lowercase characters, so as to obtain the first signature. For example, SHA-256 encoding may be performed on the second parameter sequence, but the present disclosure is not limited thereto.

It should be noted that, the manner of generating the first signature in this embodiment is not limited to the manner provided in the above embodiment, and various manners of generating signatures in the prior art are all applicable to this embodiment.

In the embodiment illustrated in FIG. 3, the first signature is generated by combining the token with the one or more service parameters required by a service invocation and the timestamp of the service invocation. The first signature, the one or more service parameters required by this service invocation, and the timestamp of this service invocation are carried simultaneously in the service invocation request. Since the one or more service parameters required by the service invocation and the timestamp of this service invocation can uniquely identify one service request performing a secure authentication, combining the token with the one or more service parameters required by the service invocation and the timestamp can achieve an effect of performing separate authentication on each service invocation, thus solving the problem that the existing single sign-on mode unable to perform separate authentication on each service invocation.

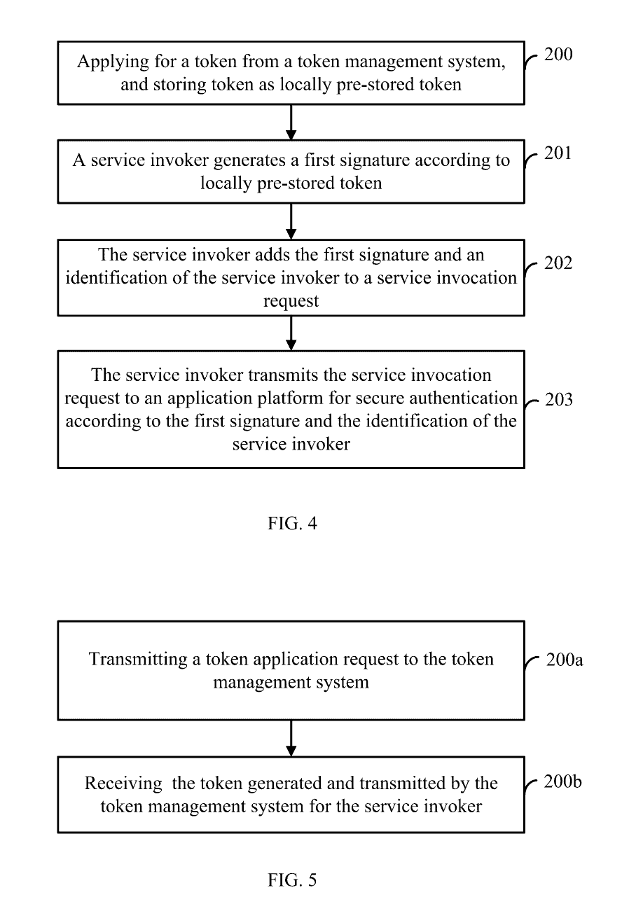

In the embodiment illustrated in FIG. 4, the service invoker can apply for a token from a token management system and locally store the applied token in step 200, before using the token. After applying for a token in step 200, the service invoker generates a first signature (step 201), adds the first signature and an identification of the service invoker to a service innovation request (step 202), and transmits the service invocation request (step 203) as discussed more fully with respect to FIG. 3.

In embodiment illustrated in FIG. 5, step 200 of FIG. 4 further includes step 200a wherein the service invoker transmits a token application request to the token management system. After transmitting a token application request, the service invoker receives the token generated by the token management system for the service invoker and transmitted by the token management system in step 200b.

In addition to applying for the token from the token management system, in some embodiments the token management system may also actively generate a token for the service invoker and distribute the token to the service invoker.

As discussed previously, the service invoker may be a service module within the application platform, or a network device outside the application platform.

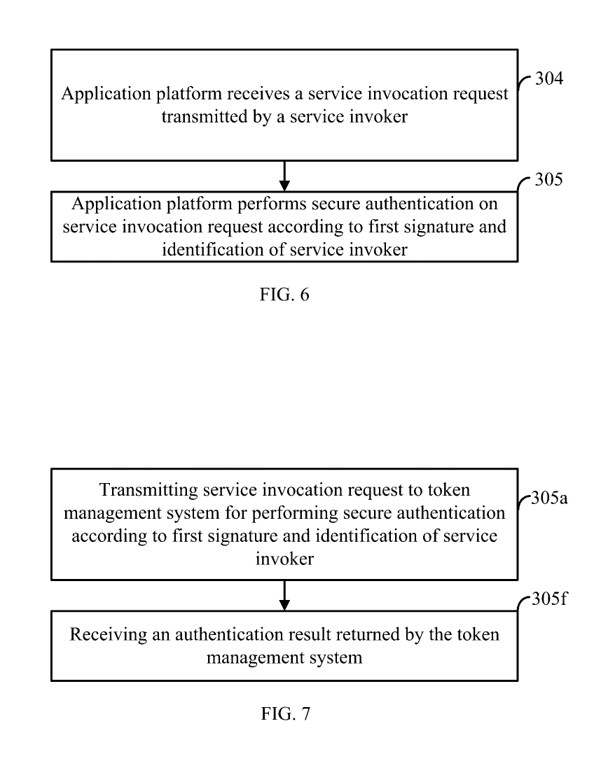

FIG. 6 presents a flow diagram of a secure authentication method according to some embodiments of the present disclosure. As shown in FIG. 6, the method includes steps 304 and 305.

In step 304, an application platform receives a service invocation request transmitted by a service invoker. In the illustrated embodiment, the service invocation request comprises a first signature generated by the service invoker according to a locally stored token, and an identification of the service invoker.

In step 305, the application platform performs a secure authentication on the service invocation request according to the first signature and the identification of the service invoker.

In the embodiment illustrated in FIG. 7, step 305 of FIG. 6 includes substeps 305a and 305f In step 305a, the application platform transmits a service invocation request to a token management system, to enable the token management system to perform a secure authentication on the service invocation request according to the first signature and the identification of the service invoker. In step 305f, the application platform receives authentication result information returned by the token management system. Correspondingly, the method may further include a step of the token management system performing a secure authentication on the service invocation request according to the first signature and the identification of the service invoker, as discussed previously.

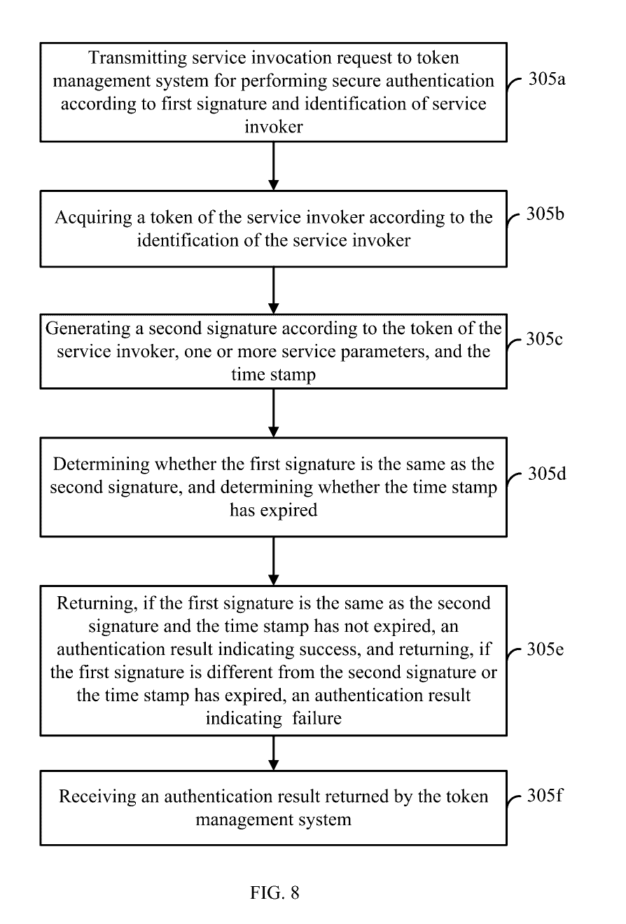

In the embodiment illustrated in FIG. 8, the first signature is generated by the service invoker according to the locally stored token, one or more service parameters required by this service invocation, and a timestamp of this service invocation. Correspondingly, the service invocation request further includes the one or more service parameters required by this service invocation and the timestamp of this service invocation. Based on the above, step 305, the process of the token management system performing a secure authentication on the service invocation request according to the first signature and the identification of the service invoker may include steps 305a through 305f, where steps 305a and 305f remain as described above.

In step 305b the token management system acquires a token of the service invoker according to the identification of the service invoker. In step 305c, the token management system generates a second signature according to the token of the service invoker, the one or more service parameters required by this service invocation, and the timestamp of this service invocation. In step 305d, the token management system determines whether the first signature is the same as the second signature, and determines whether the timestamp of this service invocation has expired.

In step 305e, if the first signature is the same as the second signature and the timestamp of this service invocation has not expired, the token management system returns authentication result information to the application platform indicating a secure authentication success. If the first signature is different from the second signature or the timestamp of this service invocation has expired, the token management system returns authentication result information to the application platform indicating a secure authentication failure.

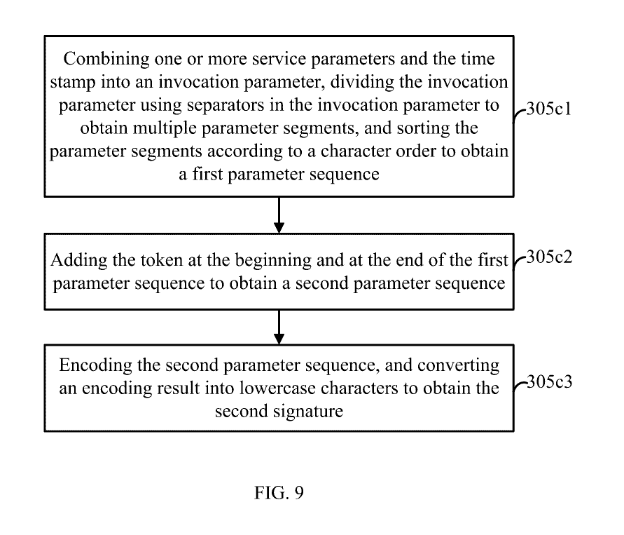

Further, in step 305c, the token management system generates the second signature according to the token of the service invoker, the one or more service parameters required by this service invocation, and the timestamp of this service invocation. One embodiment of a method for generating a second signature is presented in FIG. 9 in steps 305c1 through 305c3.

In step 305c1, the method combines the one or more service parameters required by this service invocation and the timestamp of this service invocation into an invocation parameter, divides the invocation parameter according to separators in the invocation parameter to obtain multiple parameter segments, and sorts the parameter segments according to a character order to obtain a first parameter sequence. In step 305c2, the method adds the token at the beginning and at the end of the first parameter sequence respectively, so as to obtain a second parameter sequence, and encodes the second parameter sequence. In step 305c3, the method converts an encoding result into lowercase characters, so as to obtain the second signature.

It should be noted that, the manner of generating the second signature in this embodiment is not limited to the manner provided in the above embodiment, and various manners of generating signatures in the prior art are all applicable to this embodiment.

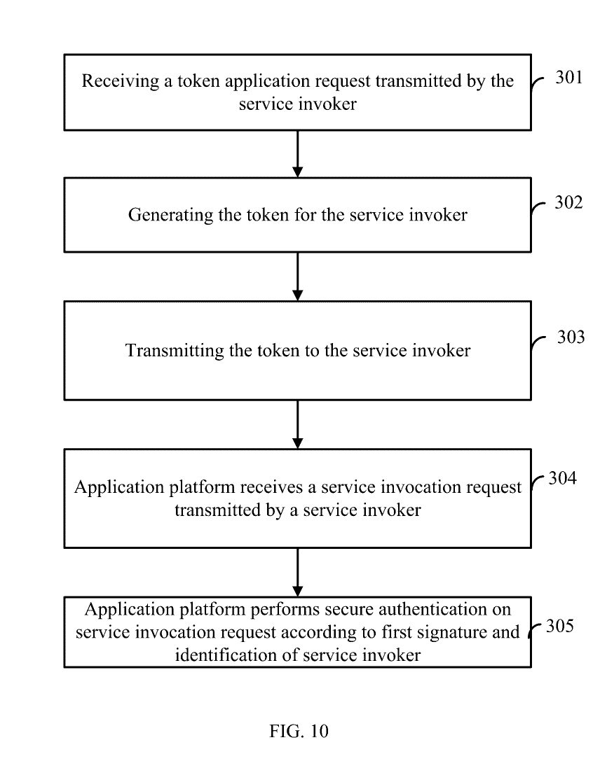

In some embodiments, before step 304 (discussed in connection with FIG. 6) the method further includes steps 301 through 303 illustrated in FIG. 10. In step 301, the token management system receives a token application request transmitted by the service invoker. In step 302, the token management system generates the token for the service invoker. In step 303, the token management system transmits the token to the service invoker. In these embodiments, steps 304 and 305 remain as described above with respect to FIG. 6.

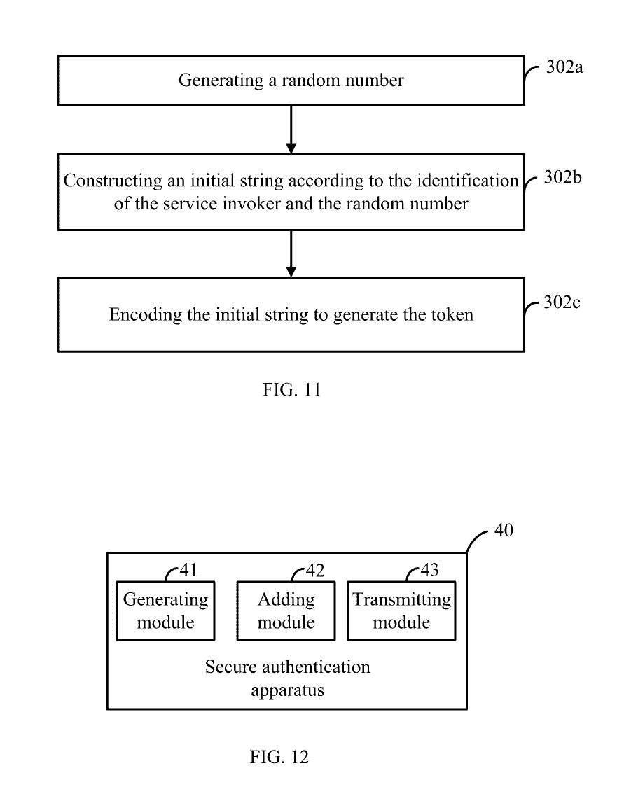

In some embodiments, step 302 (discussed in connection with FIG. 10), the implementation process of the token management system generating the token for the service invoker includes substeps 302a through 302c as illustrated in FIG. 11.

In step 302a, the method generates a random number. For example, the method may generate a random number using a SHA1PRNG algorithm, but the present disclosure is not limited to the SHA1PRNG algorithm. In step 302b, the method constructs an initial string according to the identification of the service invoker and the random number. For example, the identification of the service invoker and the random number may be concatenated to serve as the initial string. In step 302c, the method encodes the initial string to generate the token. For example, SHA-256 encoding may be performed on the initial string, but the present disclosure is not limited thereto.

It should be noted that, the manner of generating the token in this embodiment is not limited to the manner provided in the above embodiment, and various manners of generating a token in the prior art are all applicable to this embodiment.

The service invoker may be a service module within the application platform, or the service invoker may be a network device outside the application platform. In this embodiment, the application platform cooperates with the service invoker, so that the service invoker can initiate service invocation and perform a secure authentication without logging in to the application platform, thereby implementing secure authentication in a non-logged in state, and solving the problem in the prior art. Further, the application platform cooperates with the token management system, so that the token management system executes specific authentication processes, which is conducive to reducing the burden of the application platform.

It should be noted that, for ease of description, the method embodiments mentioned above are all described as a combination of a series of actions; however, persons skilled in the art should know that the present disclosure is not limited to the action order described herein, because some steps may be performed in other orders or simultaneously according to the present disclosure. Secondly, persons skilled in the art should know that the embodiments described in the specification are preferred embodiments, and actions and modules involved therein are not necessarily essential for the present disclosure.

In the above embodiments, descriptions of the embodiments each have emphases and parts that are not described in detail in some embodiment may be obtained with reference to related descriptions in other embodiments.

FIG. 12 presents a diagram of a secure authentication apparatus according to some embodiments of the present disclosure. The apparatus 40 is implemented in a service invoker, and includes a generating module 41, an adding module 42, and a transmitting module 43.

The generating module 41 is configured to generate a first signature according to a locally stored token.

The adding module 42 is configured to add the first signature and an identification of the service invoker to a service invocation request.

The transmitting module 43 is configured to transmit the service invocation request to an application platform, to enable the application platform to perform a secure authentication on the service invocation request according to the first signature and the identification of the service invoker.

In some embodiments, the generating module 41 is further configured to generate the first signature according to the locally stored token, one or more service parameters required by this service invocation, and a timestamp of this service invocation. In some embodiments, the adding module 42 is further configured to add the first signature, the identification of the service invoker, the one or more service parameters, and the timestamp to the service invocation request.

In some embodiments, the generating module 41 is further configured to combine the one or more service parameters and the timestamp into an invocation parameter, divide the invocation parameter according to separators in the invocation parameter to obtain multiple parameter segments, and sort the parameter segments according to a character order to obtain a first parameter sequence. The generating module 41 is then also configured to add the token at the beginning and at the end of the first parameter sequence respectively, so as to obtain a second parameter sequence, and encode the second parameter sequence, and convert an encoding result into lowercase characters, so as to obtain the first signature.

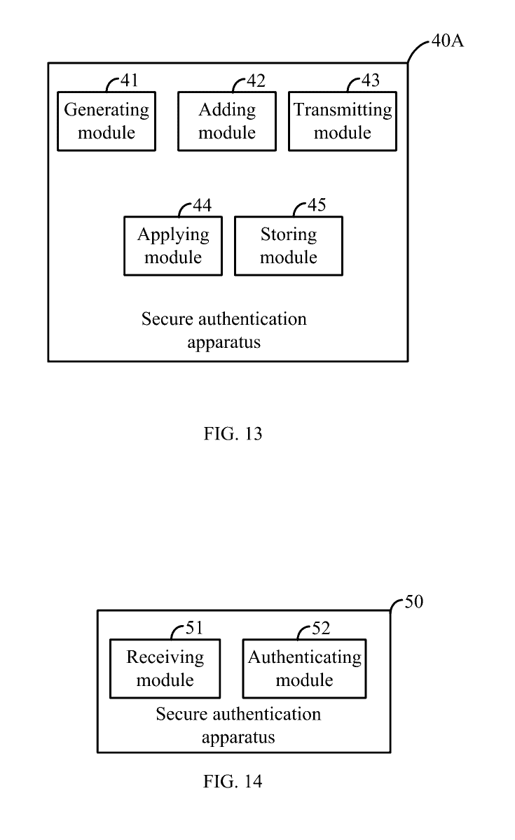

In the embodiment illustrated in FIG. 13, the secure authentication apparatus 40A further includes an applying module 44 and a storing module 45. The applying module 44 is configured to apply for a token from a token management system, and the storing module 45 is configured to locally store the token applied by applying module 44. Generating module 41, adding module 42, and transmitting module 32 of FIG. 13 remain as described with reference to FIG. 12.

In some embodiments, applying module 44 is further configured to transmit a token application request to the token management system and receive the token that is generated and transmitted by the token management system for the service invoker.

The service invoker may be a service module within the application platform, or the service invoker may be a network device outside the application platform.

In one embodiment, the secure authentication apparatus provided in this embodiment is implemented at the service invoker, so that the service invoker can initiate service invocation and perform a secure authentication without logging in to the application platform, thereby solving the problem in the prior art that a secure authentication is unable to be performed in a non-logged in state.

FIG. 14 presents a diagram of a secure authentication apparatus according to some embodiments of the present disclosure. In the illustrated embodiment, the secure authentication apparatus 50 is implemented in an application platform, and as shown in FIG. 14, the secure authentication apparatus 50 includes a receiving module 51 and an authenticating module 52.

The receiving module 51 is configured to receive a service invocation request transmitted by a service invoker, the service invocation request comprising a first signature generated by the service invoker according to a locally stored token, and an identification of the service invoker.

The authenticating module 52 is configured to perform a secure authentication on the service invocation request according to the first signature and the identification of the service invoker.

In some embodiments, the authenticating module 52 may be further configured to transmit the service invocation request to a token management system, to enable the token management system to perform a secure authentication on the service invocation request according to the first signature and the identification of the service invoker, and to receive an authentication result information returned by the token management system.

In some embodiments, the service invocation request received by the receiving module 51 further includes one or more service parameters required by this service invocation and a timestamp of this service invocation, where the first signature is generated by the service invoker according to the locally stored token, the one or more service parameters required by this service invocation and the timestamp of this service invocation. In this way, separate secure authentication may be performed on each service invocation, thereby helping to avoid counterfeit or illegitimate requests and unauthorized access attempts.

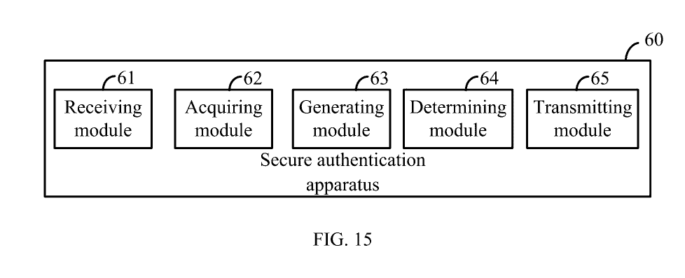

FIG. 15 presents a diagram of a secure authentication apparatus according to some embodiments of the present disclosure. The secure authentication apparatus 60 is implemented in a token management system, and as shown in FIG. 15, the apparatus includes a receiving module 61, an acquiring module 62, a generating module 63, a determining module 64, and a transmitting module 65.

The receiving module 61 is configured to receive a service invocation request transmitted by an application platform, the service invocation request comprising a first signature generated by the service invoker according to a locally stored token, one or more service parameters required by this service invocation, and a timestamp of this service invocation, an identification of the service invoker, the one or more service parameters and the timestamp.

The acquiring module 62 is configured to acquire a token of the service invoker according to the identification of the service invoker.

The generating module 63 is configured to generate a second signature according to the token of the service invoker, the one or more service parameters and the timestamp.

The determining module 64 is configured to determine whether the first signature is the same as the second signature, and determine whether the timestamp has expired.

The transmitting module 65 is configured to, if the first signature is the same as the second signature and the timestamp has not expired, return authentication result information to the application platform indicating a secure authentication success, and if the first signature is different from the second signature or the timestamp has expired, return authentication result information to the application platform indicating a secure authentication failure.

In some embodiments, the generating module 63 may be further configured to combine the one or more service parameters and the timestamp into an invocation parameter, divide the invocation parameter according to separators in the invocation parameter to obtain multiple parameter segments, and sort the parameter segments according to a character order to obtain a first parameter sequence. The generating module 63 is then also configured to add the token at the beginning and at the end of the first parameter sequence respectively, so as to obtain a second parameter sequence, and encode the second parameter sequence, and converting an encoding result into lowercase characters, so as to obtain the second signature.

In some embodiments, the receiving module 61 is further configured to receive a token application request transmitted by the service invoker. Correspondingly, the generating module 63 is then further configured to generate a token for the service invoker, and the sending module 65 is further configured to transmit the token to the service invoker.

In some embodiments, when generating the token for the service invoker, the generating module 63 is further configured to generate a random number, construct an initial string according to the identification of the service invoker and the random number, and encode the initial string to generate the token.

The secure authentication apparatus provided in this embodiment cooperates with the secure authentication apparatus provided in the above embodiment, so that the service invoker can perform service invocation and secure authentication in a non-logged in state, thereby solving the problem in the prior art that a secure authentication is unable to be performed in the non-logged in state.

For ease and clarity of descriptions, specific working processes of the system, apparatus and unit described in the above may be obtained with reference to corresponding processes in the foregoing method embodiments, and are not repeated herein.

In the several embodiments provided in the present disclosure, it should be understood that, the disclosed system, apparatus and method may be implemented in other manners. For example, the apparatus embodiment described in the foregoing is merely schematic, for example, the division of units is merely a division of logic functions, and in fact, there may be other division manners during actual implementation, for example, multiple units or components may be combined or may be integrated into another system, or some features may be omitted or not be executed. On the other hand, the displayed or discussed coupling or direct coupling or communication connection between them may be implemented through some interfaces, and indirect coupling or communication connection between apparatuses or units, and may be in the form of electrical, mechanical or other forms.

Units described as separated parts may be or may not be physically separated, parts displayed as units may be or may not be physical units, and they may be located at the same place, or be distributed to multiple network units. The objective of the solution of this embodiment may be implemented by selecting a part of or all units thereof according to actual requirements.

In addition, various function units in the embodiments of the present disclosure can be integrated in one processing unit, each unit may also exist as a separated physical presence, and two or more units may also be integrated in one unit. The integrated unit may be implemented in a form of hardware, and may also be implemented in a form of hardware plus a software function unit.

The integrated unit implemented in a form of a software functional unit may be stored in a computer readable storage medium. The software function unit is stored in a storage medium, and includes several instructions used to enable a computer device (which may be a personal computer, a server, a network device, and the like) or a processor to execute a part of steps of the methods in the embodiments of the present disclosure. The storage medium includes: a USB flash disk, a movable hard disk, a Read-Only Memory (ROM), a Random Access Memory (RAM), a magnetic disk, an optical disc, or other mediums that can store program codes.

Finally, it should be noted that, the above embodiments are merely used for describing the technical solution of the present disclosure, instead of limiting the present disclosure; although the present disclosure is described in detail with reference to the foregoing embodiments, persons of ordinary skill in the art should understand that they can still make modifications on the technical solutions recorded in the above embodiments, or perform equivalent replacements on a part of technical features thereof; these modifications or replacements will not make the essences of the corresponding technical solutions depart from the spirit and scope of the technical solutions of the embodiments of the present disclosure.

What is claimed is:

1. A method for securely authenticating a service invoker, comprising:
generating, by the service invoker, a first signature based on a locally stored token;
generating, by the service invoker, a service invocation request, wherein generating a service invocation request comprises adding the first signature and an identification of the service invoker; and
transmitting, by the service invoker, the service invocation request to an application platform for secure authentication based on the first signature and the identification of the service invoker.

2. The method according to claim 1,
wherein generating the first signature further comprises generating the first signature based on one or more service parameters required by the service invocation request and a timestamp of the service invocation request, and
wherein generating the service invocation request further comprises the adding one or more service parameters and the timestamp.

3. The method according to claim 2, wherein the generating the first signature further comprises:
combining, by the service invoker, the one or more service parameters and the timestamp into an invocation parameter, dividing the invocation parameter using separators in the invocation parameter to obtain multiple parameter segments, and sorting the parameter segments according to a character order to obtain a first parameter sequence;
adding, by the service invoker, the locally stored token at the beginning and at the end of the first parameter sequence to obtain a second parameter sequence;
encoding, by the service invoker, the second parameter sequence; and
converting the encoding result into lowercase characters.

4. The method according to claim 1, further comprising:
requesting, by the service invoker, a token from a token management system; and
storing the requested token as the locally stored token.

5. The method according to claim 4, wherein requesting a token from a token management system comprises:
transmitting, by the service invoker, a token application request to the token management system; and
receiving, by the service invoker, a token for the service invoker generated by the token management system.

6. The method according to claim 1, wherein the service invoker is a service module within the application platform.

7. The method according to claim 1 wherein the service invoker is a network device outside the application platform.

8. A method for providing secure authentication between an application platform and a service invoker, the method comprising:
receiving, by the application platform, a service invocation request transmitted by the service invoker, the service invocation request including a first signature generated by the service invoker based on a locally stored token and an identification of the service invoker; and
performing, by the application platform, a secure authentication of the service invocation request based on the first signature and the identification of the service invoker.

9. The method according to claim 8, wherein performing a secure authentication of the service invocation request comprises:
transmitting, by the application platform, the service invocation request to a token management system, the token management system performing a secure authentication according to the first signature and the identification of the service invoker; and
receiving, by the application platform, an authentication result returned by the token management system.

10. The method according to claim 9, wherein the performing a secure authentication on the service invocation request further comprises:
acquiring, by the token management system, a token of the service invoker according to the identification of the service invoker;
generating, by the token management system, a second signature according to the acquired token of the service invoker, one or more service parameters, and a timestamp;
determining, by the token management system, whether the first signature is the same as the second signature, and determining whether the timestamp has expired;
returning, by the token management system, an authentication result to the application platform indicating a secure authentication success if the first signature is the same as the second signature and the timestamp has not expired;
returning, by the token management system, an authentication result to the application platform indicating a secure authentication failure if the first signature is different from the second signature or the timestamp has expired,
wherein the first signature is generated by the service invoker according to the locally stored token, the one or more service parameters required by the service invocation request, and the timestamp of the service invocation request, and
wherein the service invocation request includes the one or more service parameters and the timestamp.

11. The method according to claim 10, wherein generating the second signature comprises:
combining, by the token management system, the one or more service parameters and the timestamp into an invocation parameter, dividing the invocation parameter using separators in the invocation parameter to obtain multiple parameter segments, and sorting the parameter segments according to a character order to obtain a first parameter sequence;
adding, by the token management system, the token at a beginning and at an end of the first parameter sequence to obtain a second parameter sequence; and
encoding, by the token management system, the second parameter sequence, and converting an encoding result into lowercase characters.

12. The method according to claim 10, wherein the method further comprises:
receiving, by the token management system, a token application request transmitted by the service invoker;
generating a token, by the token management system, for the service invoker; and
transmitting, by the token management system, the generated token to the service invoker.

13. The method according to claim 12, wherein the generating the token comprises:
generating a random number;
constructing an initial string according to the identification of the service invoker and the random number; and
encoding the initial string.

14. The method according to claim 8, wherein the service invoker is a service module within the application platform.

15. The method according to claim 8, wherein the service invoker a network device outside the application platform.

16. An apparatus for securely authenticating a service invoker, the apparatus comprising:
a processor; and
a non-transitory memory storing computer-executable instructions thereon that, when executed by the processor, cause the apparatus to:
generate a first signature based on a locally stored token;
generate a service invocation request, wherein generating a service invocation request comprises adding the first signature and an identification of the service invoker to a service invocation request; and
transmit the service invocation request to an application platform for secure authentication based on the service invocation request according to the first signature and the identification of the service invoker.

17. The apparatus according to claim 16,
wherein the instruction to generate the first signature generates the first signature based on the locally stored token, one or more service parameters required by the service invocation request, and a timestamp of the service invocation request, and
wherein the instruction to generate a service invocation request adds the first signature, the identification of the service invoker, the one or more service parameters, and the timestamp to the service invocation request.

18. The apparatus according to claim 17, wherein the instructions to generate the first signature further comprise instructions to:
combine the one or more service parameters and the timestamp into an invocation parameter, divide the invocation parameter using separators in the invocation parameter to obtain multiple parameter segments, and sort the parameter segments according to a character order to obtain a first parameter sequence;
add the token at a beginning and at an end of the first parameter sequence to obtain a second parameter sequence; and
encode the second parameter sequence and convert an encoding result into lowercase characters.

19. The apparatus according to claim 16, wherein the instructions further comprise instructions to:
request a token from a token management system; and
store the token as the locally stored token.

20. The apparatus according to claim 19, wherein the instructions to request a token from a token management system further comprise instructions to:
transmit a token application request to the token management system; and
receive the token generated and transmitted by the token management system for the service invoker.

21. The apparatus according to claim 16, wherein the service invoker is a service module within the application platform

22. The apparatus according to claim 16, wherein the service invoker is a network device outside the application platform.

23. An apparatus to securely authenticate a service invoker, the apparatus comprising:
a processor; and
a non-transitory memory storing computer-executable instructions thereon that, when executed by the processor, cause the apparatus to:
receive a service invocation request transmitted by an application platform, the service invocation request including a first signature generated by the service invoker according to a locally stored token, one or more service parameters required by the service invocation request, and a timestamp of the service invocation request, an identification of the service invoker, the one or more service parameters, and the timestamp;
acquire a token of the service invoker according to the identification of the service invoker;
generate a second signature according to the token of the service invoker, the one or more service parameters, and the timestamp;
determine whether the first signature is the same as the second signature, and determine whether the timestamp has expired;
return an authentication result to the application platform indicating a secure authentication success if the first signature is the same as the second signature and the timestamp has not expired; and
return an authentication result to the application platform indicating a secure authentication failure if the first signature is different from the second signature or the timestamp has expired.

24. The apparatus according to claim 23, wherein the instructions to generate the second signature further comprise instructions to:
combine the one or more service parameters and the timestamp into an invocation parameter, divide the invocation parameter using separators in the invocation parameter to obtain multiple parameter segments, and sort the parameter segments according to a character order to obtain a first parameter sequence;
add the token at the beginning and at the end of the first parameter sequence to obtain a second parameter sequence; and
encode the second parameter sequence, and convert an encoding result into lowercase characters to obtain the second signature.

25. The apparatus according to claim 23,
wherein the instructions to receive a service invocation request further comprise instructions to receive a token application request transmitted by the service invoker,
wherein the instructions to generate a second signature further comprise instructions to generate the token for the service invoker, and
wherein the instructions to return an authentication result further comprise instructions to transmit the token to the service invoker.

26. The apparatus according to claim 25, wherein the instructions to generate a token for the service invoker further comprise instructions to:
generate a random number;
construct an initial string according to the identification of the service invoker and the random number; and
encode the initial string.
